(19) United States
(12) Patent Application Publication
(10) Pub. No.: US 2004/0117842 A1
(43) Pub. Date: Jun. 17, 2004

(54) Method and system for personal channel programming in a media exchange network

(76) Inventors: Jeyhan Karaoguz, Irvine, CA (US); James Bennett, Laguna Beach, CA (US)

Correspondence Address: MCANDREWS HELD & MALLOY, LTD, 500 WEST MADISON STREET, SUITE 3400, CHICAGO, IL, 60661

(21) Appl. No.: 10/675,467

(22) Filed: Sep. 30, 2003

Related U.S. Application Data
(60) Provisional application No. 60/432,472, filed on Dec. 11, 2002.
(60) Provisional application No. 60/443,894, filed on Jan. 30, 2003.
(60) Provisional application No. 60/457,179, filed on Mar. 25, 2003.
(60) Provisional application No. 60/443,945, filed on Jan. 30, 2003.

(51) Int. Cl. H04N 7/173

(52) U.S. Cl. 725/105; 725/110; 725/120

(57) ABSTRACT

Aspects of programming media content in a distributed media network may include selecting at least one customized media channel established by a user based on an input from the user. A display interface may be utilized for the input selection. Media may be identified for the selected customized media channel. After selection, the media may be presented directly in one or more of the customized media channels and/or displayed in a corresponding channel view of the media channels based on the user's selections. The identified media be transferred to one or more of the customized media channels and/or scheduled to be displayed in the corresponding channel of the customized media channels. Whenever new media becomes available, the newly available media may be updated in the channel view of the corresponding customized media channels.

### FIELD OF THE INVENTION

Certain embodiments of the present invention relate to programming media content into a channel. More specifically, certain embodiments of the present invention relate to personally programming media content into customized media channels set up on a media exchange network.

### BACKGROUND OF THE INVENTION

Existing systems may program media content into channels in several ways. For example, a commercial television broadcast station may provide a television broadcast channel having certain pre-programmed media content scheduled to be broadcast at certain times. The pre-programmed media content may include television shows, news, weather, sports, movies and commercials. Similarly, a cable television company may provide certain cable television channels including certain pre-programmed media content such as cable shows, news, weather, sports, movies and commercials that are scheduled to be broadcast at certain times. A commercial radio broadcast station may provide a radio broadcast channel having certain pre-programmed media content such as music, news, weather, traffic, commercials and talk shows that are scheduled to be broadcast at certain times.

Each of these sources of media are pre-programmed and scheduled by a third party and provided to a consumer. A consumer may view the pre-programmed media at the scheduled broadcast times or may choose to record the media content for later consumption using, for example, a VCR or audio recorder. The consumer or subscriber is able to switch from channel to channel and/or possibly indicate to the third party that certain channels are not needed. Also, with pay-per-view, a consumer may select certain channels having certain programming content to be purchased. Hotels often provide access to in-room movies and video games that a consumer may select using menu functionality on a television screen. Again, the media content is all pre-programmed by a third party and simply made available to a consumer. The media content may be scheduled to be available at a certain time or may be available to a consumer on demand.

A personal computer (PC) may be utilized to select and view and/or download media content from websites on the Internet. A particular website has pre-programmed media such as articles, video files, audio files and advertisements. A consumer may store a website address in a “Favorites” menu on a PC so that it may be subsequently retrieved and utilized to navigate directly to the website. In this regard, the website media content may be pre-programmed by a third party and made available to a consumer via a PC coupled to or otherwise connected to the Internet.

A user of a PC may download digital media from a device to a PC. The digital media such as pictures from a digital camera, may be stored in files on the PC and may be viewed by the user on the PC. The user of the PC may establish a file system on the PC, which may include directories and files which may be utilized to store the digital media in various standardized PC formats. In order to access the stored digital media, the user of the PC must search through or navigate the directory structure for the media file being sought and then select the media file for consumption on the PC. Consumption may include viewing, printing and other information manipulation. The efficiency of finding a particular file may depend heavily on how well the file system was organized or structured. For example, the depth of the directories in the file system and the naming of the directories and/or files may affect navigation through the file system. Users may also have to rely on their memory and intuition in determining the location of previously saved files. The user may also initiate a search of a PC directory in order to identify and locate a particular folder or file.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Certain embodiments of the invention provide a method and system for programming media content in a distributed media network. The method for programming media content may include selecting at least one customized media channel established by a user based on at least one input from the user. A display interface may be utilized for the input selection. Any one or more of media may be selected for the customized media channel by the user. The identified media may be presented directly in one or more of the customized media channels and/or displayed in a corresponding channel view of one or more of the customized media channels based on the user's selection and identification. In one aspect of the invention, the media may also be scheduled for display in the corresponding channel view of the customized media channels. Whenever new media becomes available, the newly available media may be updated in the channel view of the corresponding customized media channels. Identified media may be transferred to one or more of the customized media channels.

Aspects of the method may also include selecting the identified media from a third party and transferring the selected media from a storage associated with the third party into one or more of the customized media channels. Although media may be transferred directly into a customized media channel, the media may be queued prior to the transfer. The queuing of the media may be based on bandwidth usage, delivery cost and/or a delivery schedule, for example. Notwithstanding, the identified media may be selected based on a device view and/or a media view. In this regard, a selection may be received that may correspond to the identified media based on the device view and/or a media view. The presentation of the identified media may be controlled via a graphical user interface that may correspond to a channel view.

Another embodiment of the invention may provide a machine-readable storage, having stored thereon, a computer program having at least one code section for programming media content in a distributed media network. The at least one code section may be executable by a machine, thereby causing the machine to perform the steps as described above for programming media content in a distributed media network.

Another embodiment of the invention provides a system for programming media content in a distributed media network. The system may include at least one processor that may select at least one customized media channel established by a user based on at lest one input from the user. A display interface may be utilized to facilitate the selection. Media may be identified for one or more of the customized media channels based on the user's input selection, which may be received and processed by the processor. The processor may present or otherwise cause the identified media to be presented in one or more of the customized media channels. The processor may also display and/or otherwise cause the identified media to be displayed in a corresponding channel view of one or more of the customized media channels based on the user's selection. The media may also be scheduled for display in the corresponding channel view of the customized media channels by the processor. Whenever new media becomes available, the processor may update the newly available media in the channel view of the corresponding customized media channels. The identified media may be transferred by the processor to one or more of the customized media channels.

In another aspect of the system, the processor may also select the identified media from a third party and transfer the selected media from a storage associated with the third party into one or more of the customized media channels. Although media may be transferred directly into the customized media channel, the processor may queue the media prior to the transfer. The queuing of the media by the processor may be based on bandwidth usage, delivery cost and/or a delivery schedule, for example. Notwithstanding, the identified media may be selected by the processor based on a device view and/or a media view. In this regard, the processor may receive a selection corresponding to the identified media based on the device view and/or a media view. The processor may also be configured to control presentation of the identified media through a graphical user interface that may correspond to the channel view. The processor may be a media processing system processor, a media peripheral processor, a customized computer processor, a storage system processor and a customized computer executing media exchange software processor.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram illustrating an embodiment of a media exchange network supporting personal programming of a media channel in accordance with various aspects of the present invention.

FIG. 1B is a flowchart illustrating an embodiment of an exemplary method that may be utilized to personally program a media channel on the media exchange network of FIG. 1A, in accordance with various aspects of the present invention.

FIG. 2 is a diagram illustrating an embodiment of an exemplary television channel guide user interface or channel view that may be utilized to support programming of a media channel according to the method of FIG. 1B on the media exchange network of FIG. 1A, for example, in accordance with various aspects of the present invention.

FIG. 3 is a schematic block diagram of a first exemplary media exchange network in accordance with an embodiment of the present invention.

FIG. 4 is a schematic block diagram of performing personal media exchange over a second exemplary media exchange network in accordance with an embodiment of the present invention.

FIG. 5 is a schematic block diagram of performing third-party media exchange over a third exemplary media exchange network in accordance with an embodiment of the present invention.

FIG. 6 is an exemplary illustration of a TV guide channel user interface in accordance with an embodiment of the present invention.

FIG. 7 is an exemplary illustration of several instantiations of a TV guide channel user interface of FIG. 4 in accordance with an embodiment of the present invention.

FIG. 8 is an exemplary illustration of a TV guide channel user interface showing several options of a pushed media in accordance with an embodiment of the present invention.

FIG. 9A is a schematic block diagram of a media processing system (MPS) interfacing to media capture peripherals in accordance with an embodiment of the present invention.

FIG. 9B illustrates an alternative embodiment of a media processing system (MPS) in accordance with various aspects of the present invention.

FIG. 10 is a schematic block diagram of a PC and an MPS interfacing to a server on a media exchange network in accordance with an embodiment of the present invention.

FIG. 11 is a schematic block diagram of a PC interfacing to personal media capture devices and remote media storage on a media exchange network in accordance with an embodiment of the present invention.

### DETAILED DESCRIPTION OF THE INVENTION

Certain embodiments of the invention relate to programming media content into a media channel and may include personally programming media content into customized media channels set up on a media exchange network. Aspects of the invention may also include a method and system for programming media content in a distributed media network. Accordingly, the system for programming media content may include selecting at least one customized media channel established by a user based on at least one input from the user. At least one of media may be selected for the customized media channel based on the selection. After the selection, the identified media may be presented in one or more of the customized media channels and/or displayed in a corresponding channel view of one or more of the customized media channels based on the user's selection. The identified media may also be transferred to one or more of the customized media channels. The method may also include scheduling the media to be displayed in the corresponding channel view of at least one of the customized media channels. Whenever new media becomes available, the newly available media may be updated in the channel view of the corresponding customized media channels.

In another aspect of the invention, the identified media may be selected from a third party and the selected media transferred from a storage associated with the third party into one or more of the customized media channels. Although the media may be transferred directly into the customized media channel, the media may be queued prior to the transfer. In this regard, the queuing of the media may be based on exemplary factors such as bandwidth usage, delivery cost and/or a delivery schedule. In any case, a selection of the identified media may be received based on a device view and/or a media view and the presentation of the identified media may be controlled via a graphical user interface corresponding to a channel view.

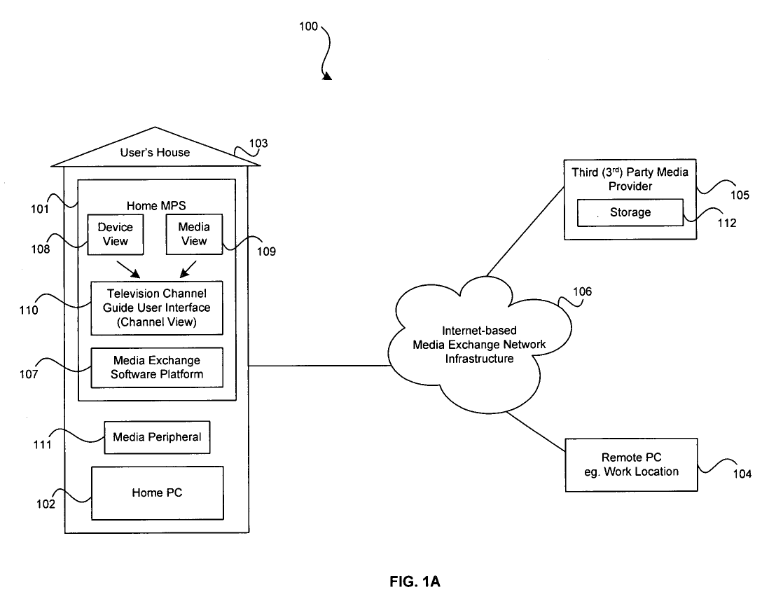

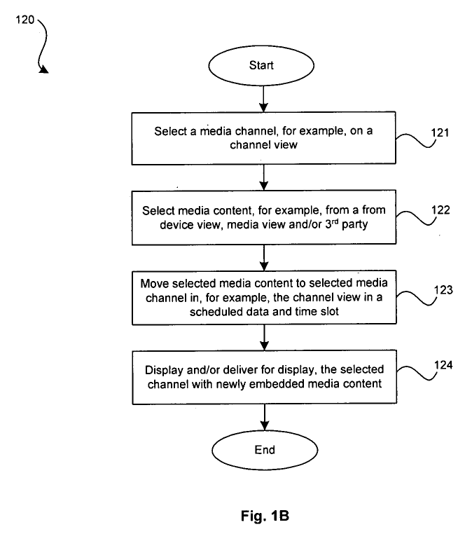

FIG. 1A is a diagram illustrating an embodiment of a media exchange network 100 supporting personal programming of a media channel in accordance with various aspects of the present invention. Referring to FIG. 1A, the media exchange network 100 may include a media processing system (MPS) 101, a PC 102 and a media peripheral 111. The media processing system 101, the PC 102 and the media peripheral 111 may be situated at a first location 103 such as a first home, which may be a user's home 103. Accordingly, the media processing system 101 may be referred to as a home media processing system 101 and the PC 102 referred to as a home PC 102. The media exchange network 100 may also include a remote PC 105 and a third (3^{rd}) party media provider 105. The third (3^{rd}) party media content provider 105 may supply third (3^{rd}) party media content on the media exchange network 100. The third (3^{rd}) party media content provider 105 may include at least one storage system 112. The storage system may include, but is not limited to, a database, a CD tower, a jukebox, a magnetic disk, an optical disk, a solid state memory device, a tape device, and a media peripheral, a server, a media processing system and a computer having various memory and/or storage devices.

A media processing system may also comprise a set-top-box (STB), a PC, and/or a television with a media management system (MMS). A media management system may also be referred to as a media exchange software (MES) platform. Notwithstanding, a media management system may include a software platform operating on at least one processor that may provide certain functionality including user interface functionality, distributed storage functionality, networking functionality, and automatic control and monitoring of media peripheral devices. For example, a media management system may provide automatic control of media peripheral devices, automatic status monitoring of media peripheral devices, and inter-home media processing system routing selection. A media processing system may also be referred to as a media-box and/or an M-box. Any personal computer may indirectly access and/or control any media peripheral device in instances where the personal computer may include a media management system. Such access and/or control may be accomplished through various communication pathways via the media processing system or outside of the media processing system. A media processing system may also have the capability to automatically access and control any media peripheral device without user interaction and/or with user intervention. A personal computer (PC) may include media exchange software running on or being executed by the personal computer and may be referred to as a media processing system. The media processing system may also include a speech recognition engine that may be adapted to receive input speech and utilize the input speech control various functions of the media processing system.

Each of the elements or components of the network for communicating media or media exchange network may be identified by a network protocol address or other identifier which may include, but is not limited to, an Internet protocol (IP) address, a media access control (MAC) address and an electronic serial number (ESN). Examples of elements or components that may be identified by such addresses or identifiers may include media processing systems, media management systems, personal computers, media or content providers, media exchange software platforms and media peripherals.

The media exchange network 100 may further include an Internet-based media exchange network infrastructure 106 that may provide an access and/or transport medium for the home media processing system 101, the home PC 102, the remote PC 104 and the third (3^{rd}) party media provider 105. A personal computer (PC) comprising media exchange software running on or being executed by the personal computer, may also be referred to as a media processing system.

The home media processing system 101 may include a media exchange software (MES) platform 107 providing a device view 108, a media view 109 and/or a television channel guide user interface 110 to a user of the home MPS 101. The television channel guide user interface 110 may also be referred to as a channel view 110. In accordance with an embodiment of the invention, the home PC 102 and the remote PC 104 may also each include a media exchange software platform, which may provide a device view, media view and/or channel view.

The device view 108 may include a table of devices on the media exchange network 100 and corresponding media content categories within those devices. The media view 109 may include a table of media content categories on the media exchange network and corresponding specific media content within those categories. The television channel guide user interface or channel view 110 may present or display a list of channels and corresponding programmed media content scheduled by time and date, for example. U.S. patent application Ser. No. ______ (Attorney Docket No. 14276US02) filed Sep. 30, 2003 provides an exemplary media view and a device view, and is incorporated herein by reference in its entirety.

The media exchange software platform 107 may also provide the functional capability that may allow a user of the media processing system 101 to personally program media channels with media content using, for example, a remote control. In this regard, the remote control may be adapted to interact with or otherwise control the operation of the media processing system 101. Similarly, the media exchange platforms in home PC 102 and remote PC 104 may also provide the functional capability that may permit a user of the home PC 102 and/or the remote PC 104 to personally program media channels with media content. In this regard, the user may utilize an input device that may function as an I/O device and/or navigation tool to program the media channels. For example, a mouse, a touch-screen display and/or a keyboard may be utilized to interact with the PCs 102, 104. Media content may be accessed by a user via the device view 108, the media view 109, and/or from another source such as a media peripheral 111 and/or a third (3^{rd}) party media provider 105.

FIG. 1B is a flowchart illustrating an embodiment of an exemplary method 120 that may be utilized to personally program a media channel on the media exchange network 100 of FIG. 1A, in accordance with various aspects of the present invention. In step 121, a previously set up media channel is selected on the channel view 110. In step 122, media content may be selected from the device view 108, media view 109, media peripheral 111, or the third (3^{rd}) party provider 105. In step 123, the selected media content may be moved to the selected media channel in the channel view 110 under a scheduled date and time slot, for example. In step 124, the selected media channel may be displayed on the channel view 110 showing the newly embedded media content. Also in step 124, the new media content may be delivered for display to another location such as, a friend or family member media processing system or personal computer.

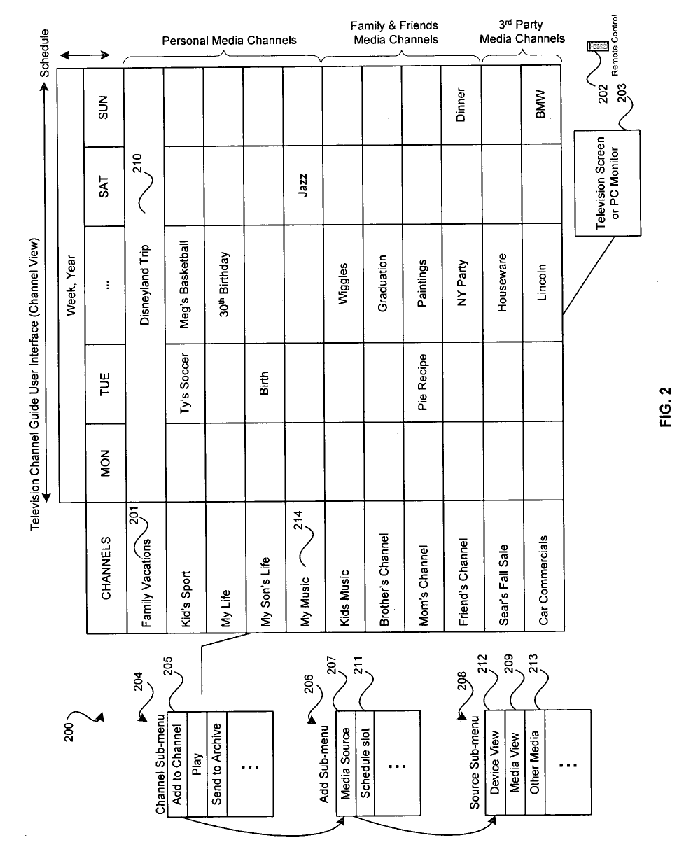

FIG. 2 is a diagram illustrating an embodiment of an exemplary television channel guide user interface or channel view 200 that may be utilized to support programming of a media channel according to the method 120 of FIG. 1B on the media exchange network 100 of FIG. 1A, for example, in accordance with various aspects of the present invention. A user of the media processing system 101 may desire to add media content to a channel 201 that was previously set up on their channel view 200 and named “Family Vacations”. The user, viewing the channel view 200 on their television screen 203 and using their remote control 202, may select the channel 201.

In operation, in instances where the channel 201 may be selected, a “Channel” sub-menu 204 may appear on the television screen 203. For example, the “Channel” sub-menu may be displayed as a pull-down or drop-down menu presented on the television screen 203. Based on particular selections in the “Channel” sub-menu 204, the user may select, for example, an “Add to channel” option 205. Upon selecting the “Add to channel” option 205, based on available selections, an “Add” sub-menu 206, for example, may be presented on the television screen 203. From the “Add” sub-menu 206, the user may then select the “Media source” option 207. Upon selection of the “Media source” option 207, a “Source” sub-menu 208 may be presented on the television screen 203. From the “Source” sub-menu 208, the user may select, for example, the “Media view” option 209. The media view 109 may be presented on, for example, the television screen 203 where it may be displayed in a table of media content categories versus specific media content. The user may then select specific media content from the media view such as a “Disneyland Trip” 210.

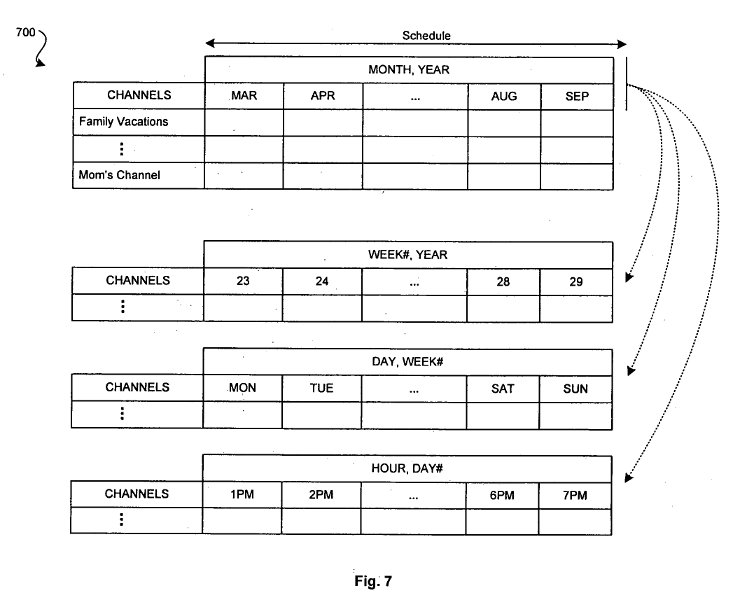

The user may return or navigate to the immediately prior sub-menu, select “Schedule slot” 211 from the “Add” sub-menu 206 and enter or otherwise input a specific date and time. For example, a specific data and time may be entered to schedule the “Disneyland Trip” 210 for viewing. Accordingly, the “Disneyland Trip” 210 may appear in the channel view 200 under the “Family Vacations” channel 201 at the selected date and time. FIG. 7 illustrates various exemplary schedule viewing options in accordance with various embodiments of the invention. The schedule may be viewed as, for example, “month, year”, “week#, year”, “day, week#”, or “hour, day”. Similarly, the programming of the channel 201 may be performed using the home PC 102 at user's home 103, or using the remote PC 104 at, for example, a work office and using a mouse or keyboard to perform the selections.

In another aspect of the invention, a user may select the “Device view” option 212 or the “Other media” option 213 from the “Source” sub-menu 208. The device view 108 may present or display a table of devices that may be currently active on the media exchange network 100 along with corresponding media content categories stored in the devices. The device view 108 may provide a user with the capability to select a particular media content category stored on a particular device on the media exchange network 100. For example, the user may have the capability to select a particular album title from a list of titles whose corresponding music may be physically stored on a CD jukebox player coupled to the media exchange network 100. The CD jukebox player may be situated at a friend's home or another remote location, for example. The third (3^{rd}) party media provider 105 may also provide the media content category. Notwithstanding, at least some of the tracks for the selected album may be made available to the user through the channel view 200 under, for example, the “My music” channel 214. Alternatively, the user may select the device itself such as the CD player jukebox and at least a portion of the songs stored in the CD jukebox player may be made available to the user through the channel view 200 under, for example, the “My music” channel 214.

If the user selects the “Other media” option 213 from the “Source” sub-menu 208, sources of other media such as third (3^{rd}) party media content or media peripherals may be present to and/or displayed on the television screen 203. For example, when a user selects the “Other media” option 213 from the “Source” sub-menu 208, a media peripheral icon corresponding to media peripheral 111 may appear on the television screen 203. The media peripheral 111 may be, for example, the user's digital camera and may be coupled or otherwise connected to the media exchange network 100. Notwithstanding, in instances where the user may select the media peripheral icon on the television screen 203, a list of files may appear on the television screen 203, representing digital pictures taken by the user. Accordingly, the user may select various files which may be added to the channel view 200 under the previously selected channel 201.

In instances where a user may schedule media content to their channel view, the media content may have previously been downloaded to the user's media processing system and/or PC. Accordingly, the downloaded media content may be scheduled for viewing at any time. However, if the selected media content only exists at some remote location on the network, then the selected media content may need to be downloaded to, for example, the user's media processing system prior to viewing. Depending on the downloading option selected, a conflict may arise between the scheduled time slot and when the selected media content is available for consumption. For example, a user of the media exchange network 100 may wish to add to the user's channel view 110 an image file that may currently be stored at a location of the third (3^{rd}) party provider 105. A sub-menu on the channel view 110 may provide several options for selecting tasks corresponding to activities such as purchasing and downloading the image file.

In an illustrative embodiment of the invention, a first, most expensive option may be “Express Delivery” which would deliver the image file to the media processing system 101 in approximately 18 minutes using queuing and cost $1.20, for example. The image file may be stored in an MPEG 2 format that was recorded at a rate of 4 Mbps, for example. Queuing may include buffering and delivering a previous at least a portion of the media and then buffering and/or delivering a subsequent portion of the media. For example, a first part of the image file may be buffered and delivered first, then a second part may be buffered and delivered next, and so on until the entire image file is delivered. In this regard, the media may be placed in a queue and then subsequently delivered based on certain queuing algorithms or schemes such as a last-in-first-out (LIFO) or first-in-first-out (FIFO). Notwithstanding, a second, less expensive option may be “Normal Delivery” which would deliver the image file in 2 hours and 13 minutes without queuing and cost $0.59, for example. In this case, the image file may be stored in an MPEG 2 format that was recorded at a rate of 1.5 Mbps, for example.

A third, least expensive option may be include “Overnight Delivery” which may deliver the image file by the next morning and cost only $0.05, for example. The image file may be stored in an MPEG 2 format that was recorded at a rate of 19 Mbps and stored on a server, for example. Accordingly, if the user chooses the “Overnight Delivery” option but schedules the image file in his channel view 110 to be viewed this afternoon, a conflict would arise. Under these circumstances, the image file may not be delivered until the next morning or overnight and, therefore, will not be available for viewing at the scheduled time. In general, factors such as cost, a requested delivery time or date, and bandwidth consumption may be considered for delivery and queuing.

In accordance with an embodiment of the invention, in instances where a user may display a channel view” 110 on a TV screen 203, the scheduled image file may be listed in the channel view 110 at the scheduled time. However, when the user tries to select and view the image file at the scheduled time, a message may be presented on the television screen 203 notifying the user that the image file will not be available until, for example, 6:00 a.m. the following morning.

A major challenge is to be able to transfer and share many different types of digital media, data, and services between one device/location and another with ease while being able to index, manage, and store the digital media and data.

For example, it is desirable to be able to distribute and store many types of digital media in a PC and/or television environment in a user-friendly manner without requiring many different types of software applications and/or unique and dedicated interfaces. Any networking issues or other technical issues should be transparent to the users. It is also desirable to take advantage of existing hardware infrastructure, as much as possible, when providing such capability.

In an embodiment of the present invention, a media exchange network is provided that enables many types of digital media, data, and/or services to be stored, indexed, viewed, searched for, pushed from one user to another, and requested by users, using a media guide user interface. The media exchange network also allows a user to construct customized media channels such as personal media channels that comprise the user's personal digital media (e.g., captured digital pictures, digital video, digital audio, etc.), request that third-party media channels be constructed from third-party digital media, and access the media channels pushed to him by other users on the media exchange network.

PC's may be used but are not required to interface to the media exchange network for the purpose of exchanging digital media, data, and services. Instead, set-top-boxes or integrated MPS's (media processing systems) may be used with the media exchange network to perform all of the previously described media exchange functions using a remote control with a television screen.

Current set-top-boxes may be software enhanced to create a MPS that provides full media exchange network interfacing and functionality via a TV screen with a TV guide look-and-feel. PC's may be software enhanced as well and provide the same TV guide look-and-feel. Therefore, the media exchange network supports both PC's and MPS's in a similar manner. Alternatively, a fully integrated MPS may be designed from the ground up, having full MPS capability.

In the case of an MPS configuration, the user takes advantage of his remote control and TV screen to use the media exchange network. In the case of a PC configuration, the user takes advantage of his keyboard and/or mouse to use the media exchange network.

An MPS or enhanced PC is effectively a storage and distribution platform for the exchange of personal and third party digital media, data, and services as well as for bringing the conventional television channels to a user's home. An MPS and/or PC connects to the media exchange network via an existing communication infrastructure which may include cable, xDSL, satellite, ISDN and/or other similar access and transport technologies. The connection to the communication infrastructure may be hard-wired or wireless.

The media exchange network allows users to effectively become their own broadcasters from their own homes by creating their own media channels and pushing those media channels to other authorized users on the media exchange network, such as friends and family members.

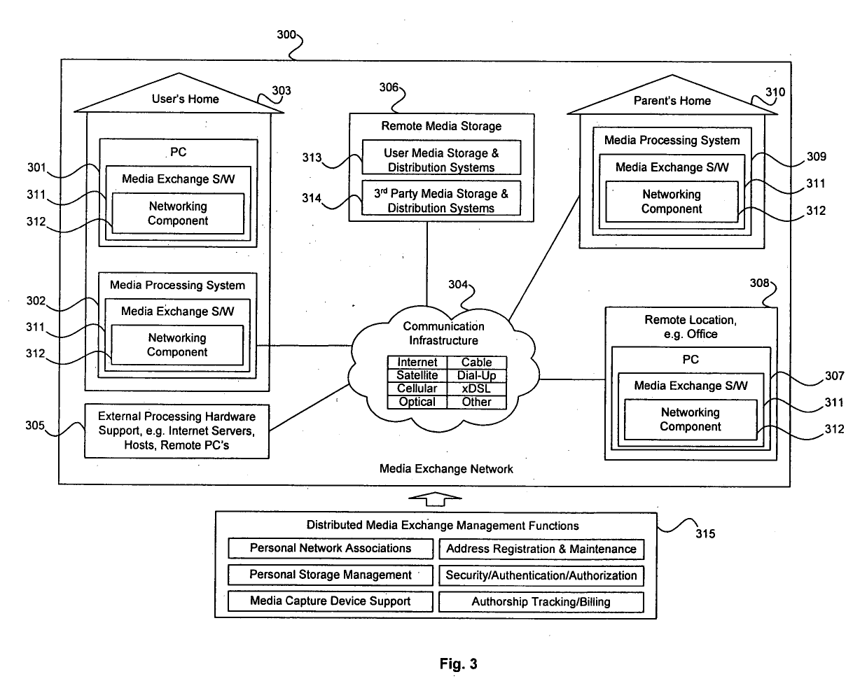

FIG. 3 comprises a media exchange network 300 for exchanging and sharing digital media, data, and services in accordance with an embodiment of the present invention. The media exchange network 300 is a secure, closed network environment that is only accessible to pre-defined users and service providers. The media exchange network of FIG. 3 comprises a first PC 301 and a first media processing system (MPS) 302 at a user's home 303, a communication infrastructure 304, external processing hardware support 305, remote media storage 306, a second PC 307 at a remote location 308 such as an office, and a second MPS 309 at a parent's home 310.

The PC's 301 and 307 and the MPS's 302 and 309 each include a media exchange software (MES) platform 311 and a networking component 312 for connectivity. The MES platform 311 provides multiple capabilities including media “push” capability, media “access” capability, media channel construction/selection, image sequence selection, text and voice overlay, channel and program naming, inter-home routing selection, authorship and media rights management, shared inter-home media experience, billing service, and an integrated media guide interface providing a TV channel guide look-and-feel.

The external processing hardware support 305 comprises at least one server such as a centralized internet server, a peer-to-peer server, or cable head end. The server may alternatively be distributed over various hosts or remote PC's. The MES platform 311 may also reside on the external processing hardware support server 305. The remote media storage 306 may comprise user media storage and distribution systems 313 and/or third party media storage and distribution systems 314.

The communication infrastructure 304 may comprise at least one of internet infrastructure, satellite infrastructure, cable infrastructure, dial-up infrastructure, cellular infrastructure, xDSL infrastructure, optical infrastructure, or some other infrastructure. The communication infrastructure 304 links the user's home 303, parent's home 310, remote media storage 306, and remote location office 308 to each other (i.e., the communication infrastructure 304 links all users and service providers of the media exchange network 300).

The various functions 315 of the media exchange network 300 comprise generating personal network associations, personal storage management, media capture device support, security/authentication/authorization support, authorship tracking and billing and address registration and maintenance. These media exchange management functions 315 may be distributed over various parts of the media exchange network 300. For example, the personal network associations and personal storage management functions may be integrated in the PC 301 at the user's home 303.

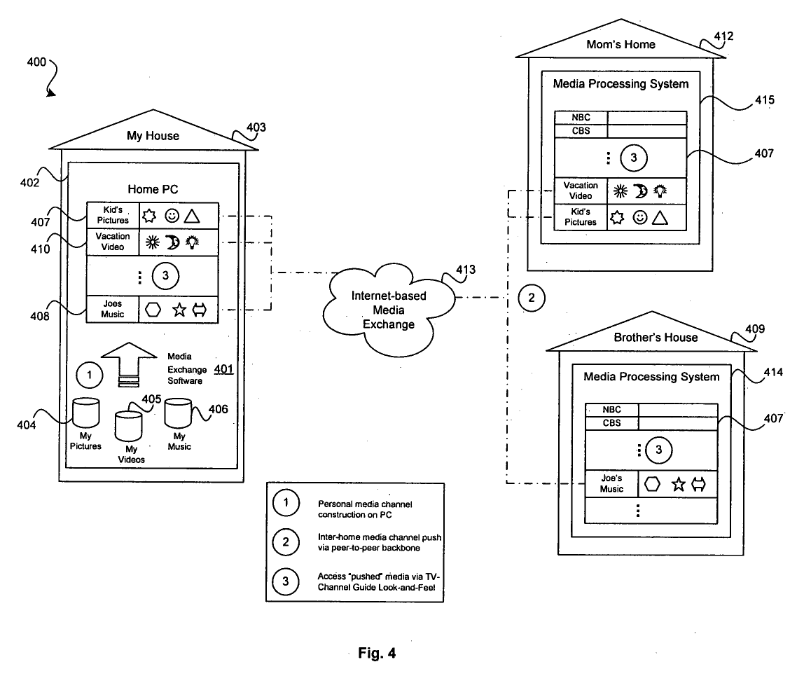

FIG. 4 illustrates an example of personal media exchange over a media exchange network 400 in accordance with an embodiment of the present invention. In step 1, the media exchange software (MES) platform 401 is used to construct personal media channels on a PC 402 by a user at “my house” 403. For example, with various media stored on the PC 402 such as digital pictures 404, videos 405, and music 406, the MES platform 401 allows the digital media to be organized by a user into several channels having a media guide user interface 407 on the PC 402.

In step 2, the user at “my house” 403 pushes a media channel 408 (e.g., “Joe's Music”) to “brother's house” 409 and pushes two media channels 410 and 411 (e.g., “Vacation Video” and “Kid's Pictures”) to “Mom's house” 412 via a peer-to-peer server 413 over the internet-based media exchange network 400. “Brother's house” 409 includes a first MPS 414 connected to the media exchange network 400. “Mom's house” 412 includes a second MPS 415 connected to the media exchange network 400. The MPS's 414 and 415 also provide a media guide user interface 407.

In step 3, brother and/or Mom access the pushed media channels via their respective media processing systems (MPS's) 414 and 415 using their respective MPS TV screens and remote controls.

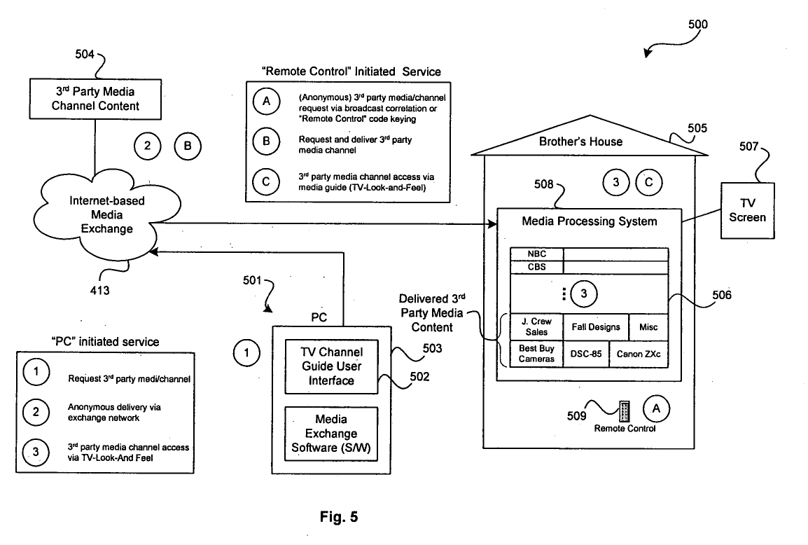

FIG. 5 illustrates an example of third-party media exchange over a media exchange network 500 in accordance with an embodiment of the present invention. In step 1, a PC-initiated third-party request is made by a first party 501 via an internet-based media exchange network 500 using a media guide user interface 502 on a PC 503. In step 2, an anonymous delivery of the requested third-party channel 504 is made to a second party 505 via the internet-based media exchange network 500. In step 3, the second party 505 accesses the third-party channel 504 using a media guide user interface 506 on a TV screen 507 that is integrated into an MPS 508.

Similarly, in step A, an MPS-initiated third-party request is made by a second party 505 via an internet-based media exchange network 500 using a media guide user interface 506 on a TV screen 507 using a remote control 509. The second party 505 may key in a code, using his remote control 509, that is correlated to a commercial or some other third party broadcast media. In step B, an anonymous delivery of the requested third-party channel 504 is made to a first party 501 via the internet-based media exchange network 500. In step C, the first party 501 accesses the third-party channel 504 using a media guide user interface 502 on a PC 503.

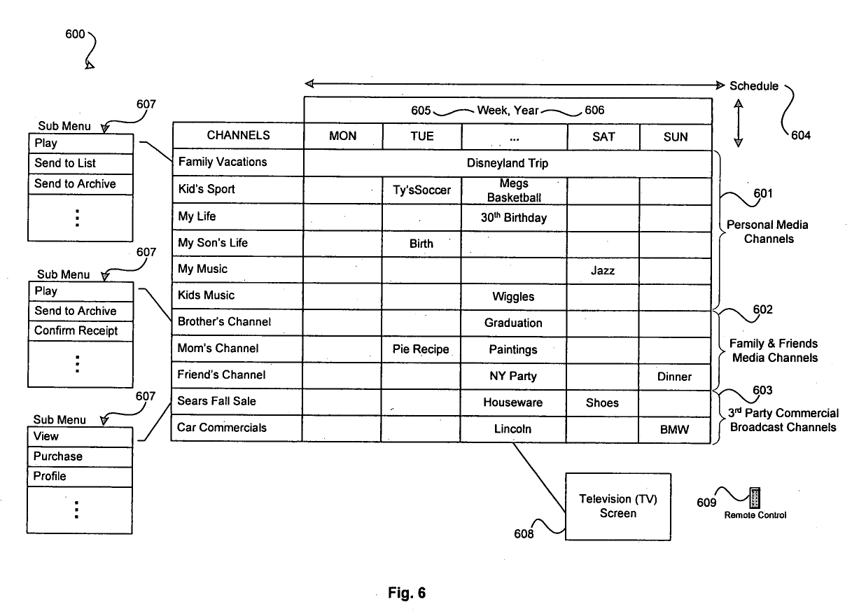

FIG. 6 illustrates a media guide user interface 600 in accordance with an embodiment of the present invention. The media guide user interface 600 may be displayed on a TV screen 608 and controlled by a remote control device 609. Also, the media guide user interface 600 may be displayed on a PC monitor and controlled by a keyboard or mouse.

The media guide user interface 600 may be configured not only for conventional TV channels but also for personal media channels 601 that are constructed by a user of a media exchange network, friend's and family's media channels 602 constructed by friends and family, and third party channels 603 that are constructed by third parties either upon request by a user of a media exchange network or based on a profile of a user.

The personal media channels 601 may include, for example, a “family vacations channel”, a “kid's sports channel”, a “my life channel”, a “son's life channel”, a “my music channel”, and a “kid's music channel”. The friends and family media channels 602 may include, for example, a “brother's channel”, a “Mom's channel”, and a “friend's channel”. The third party media channels 603 may include, for example, a “Sears Fall sale channel” and a “car commercials channel”. The media channels in the channel view 200 such as personal media channels, friends' and family's media channels, and third (3^{rd}) party media channels, may be generically referred to as customized media channels.

Each media channel may correspond to a schedule 604 showing, for example, a week 605 and a year 606. For example, under the “kid's sports channel”, Ty's soccer game could be scheduled to be viewed on Tuesday of the current week 605 and current year 606. For each media channel, a sub-menu 607 allows for selection of certain control and access functions such as “play”, “send to list”, “send to archive”, “confirm receipt”, “view”, “purchase”, and “profile”.

FIG. 7 illustrates possible multiple instantiations of a media guide user interface 700 in accordance with an embodiment of the present invention. The media guide user interface 700 may be viewed with a schedule having formats of, for example, “month, year”, “week#, year”, “day, week#”, or “hour, day”.

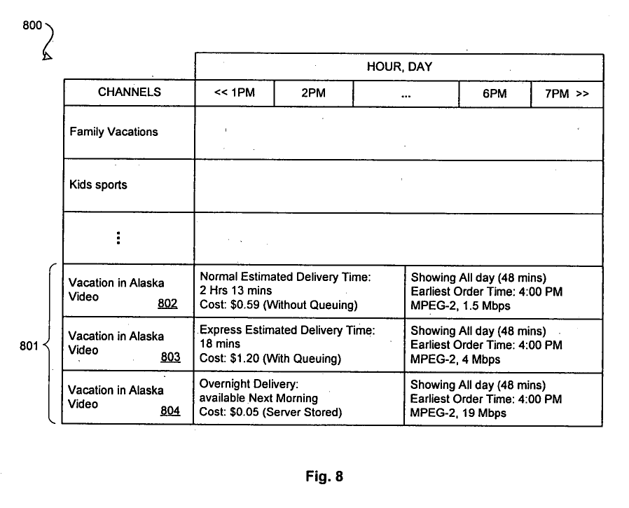

Referring to FIG. 8, a user of a media exchange network may push a media channel (e.g., “Vacation in Alaska Video”) to a friend who is on the same media exchange network. The media guide user interface 800 may give the friend several options 801 for how to accept and download the pushed media in accordance with an embodiment of the present invention.

For example, a first, most expensive option 803 may be “Express Delivery” which would deliver the pushed media to the friend in 18 minutes using queuing and cost $1.20, for example. The pushed media may be stored in a file in an MPEG 2 format that was recorded at a rate of 4 Mbps, for example. Queuing comprises buffering and delivering a previous part of the media and then buffering and delivering a next part of the media. For example, a first six minutes of the “Vacation in Alaska Video” may be buffered and delivered first, then a second six minutes may be buffered and delivered next, and so on until the entire media is delivered.

A second, less expensive option 802 may be “Normal Delivery” which would deliver the pushed media in 2 hours and 13 minutes without queuing and cost $0.59, for example. The pushed media may be stored in a file in an MPEG 2 format that was recorded at a rate of 1.5 Mbps, for example.

A third, least expensive option 804 may be “Overnight Delivery” which would deliver the pushed media by the next morning and cost only $0.05, for example. The pushed media may be stored in a file in an MPEG 2 format that was recorded at a rate of 19 Mbps and stored on a server, for example.

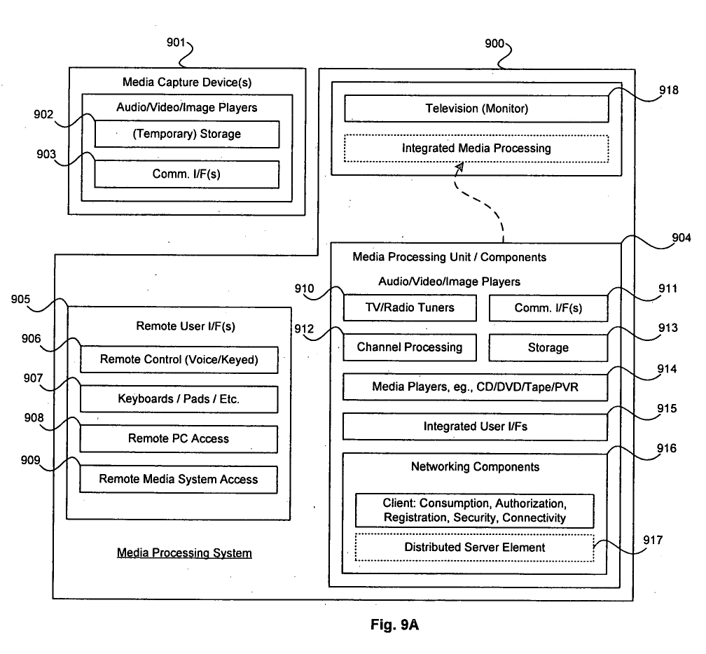

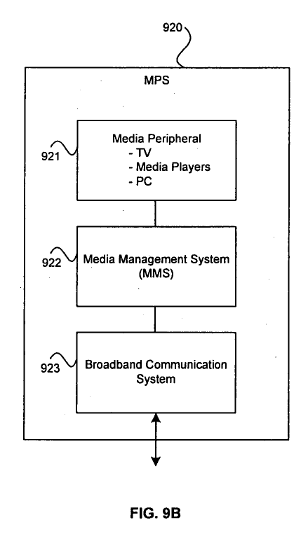

FIG. 9A illustrates the detailed elements of a media processing system (MPS) 900 and media capture devices 901 in accordance with an embodiment of the present invention. The media capture devices 901 may comprise audio, video, and image players, such as digital cameras, digital camcorders, and MP3 players, that each include a temporary storage area 902 and a communication interface 903 such as, for example, a USB interface or a wireless interface. The media capture devices 901 have the capability to interface to an MPS and a PC.

The MPS 900 comprises a media processing unit (MPU) 904, remote user interface(s) 905, and a TV screen 918 to provide integrated media processing capability and indirect user interface capability. The remote user interfaces 905 may comprise a voice or keyed remote control 906, keyboards and pads 907, a remote PC access interface 908, and a remote media system access interface 909 (i.e., providing access from another MPS).

The media processing unit (MPU) 904 comprises TV and radio tuners 910 for image and audio consumption, communications interfaces 911, channel processing 912 (creating, storing, indexing, viewing), storage 913, media players 914 (CD, DVD, Tape, PVR, MP3), an integrated user interface 915 (to provide a TV channel guide look-and-feel), networking components 916 to provide client functions such as consumption (billing), authorization (e.g., using digital certificates and digital ID's), registration, security, and connectivity. In an alternative embodiment of the present invention, the networking components 916 may include a distributed server element 917 that is part of a distributed server.

FIG. 9B illustrates an alternative embodiment of a media processing system (MPS) 920 in accordance with various aspects of the present invention. The MPS 920 is essentially an enhanced set-top-box for viewing and interacting with various user interfaces, media, data, and services that are available on the media exchange network using, for example, a remote control. The MPS 920 comprises a media peripheral 921, a MMS (media management system) 922, and a broadband communication interface 923.

The media peripheral 921 may include a TV (television), a PC (personal computer), and media players (e.g., a CD player, a DVD player, a tape player, and a MP3 player) for video, image, and audio consumption of broadcast and/or personal channels. The broadband communication interface 923 may include internal modems (e.g., a cable modem or DSL modem) or other interface devices in order to communicate with, for example, a cable or satellite headend.

The MMS 922 includes a software platform to provide functionality including media “push” capability, media “access” capability, media channel construction/selection, image sequence selection, text and voice overlay, channel and program naming, inter-home routing selection, authorship and media rights management, shared inter-home media experience, billing service, and a media guide user interface providing an integrated TV channel guide look-and-feel.

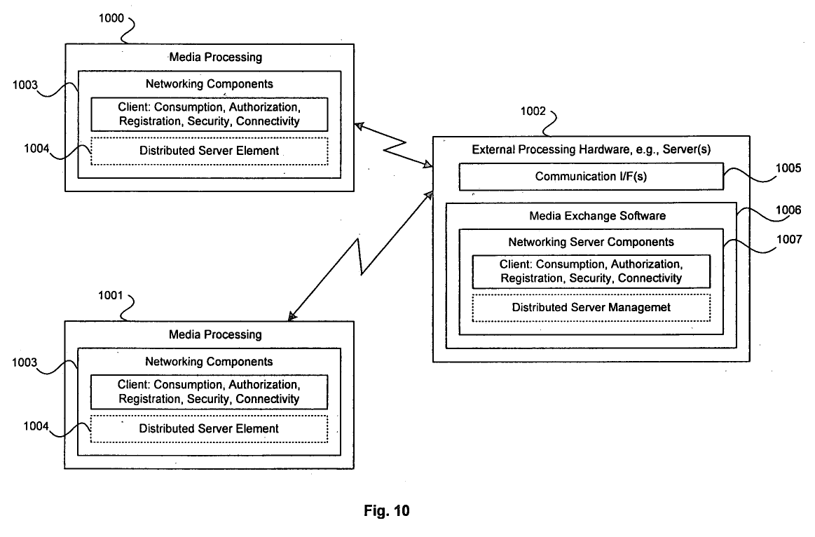

FIG. 10 illustrates connectivity between a PC 1000, an MPS 1001, and external processing hardware 1002 (e.g., a server) in accordance with an embodiment of the present invention. The PC 1000 and MPS 1001 include networking components 1003 to provide client functions such as consumption (billing), authorization, registration, security, and connectivity. Alternatively, the PC 1000 and MPS 1001 may include a distributed server element 1004 that is part of a distributed server.

The PC 1000 and MPS 1001 connect to the external processing hardware 1002 via wired or wireless connections. The external processing hardware 1002 comprises a distributed server or peer-to-peer server. The external processing hardware 1002 also comprises communication interfaces 1005 (e.g., cable interfaces, optical interfaces, etc.) and a media exchange software (MES) platform 1006. The MES platform 1006 in the external processing hardware 1002 allows for communication with the PC 1000 and MPS 1001 which may also use the same MES platform 1006. The external processing hardware 1002 also includes networking server components 1007 to provide the similar client functions such as consumption (billing), authorization, registration, security, and connectivity at the server side.

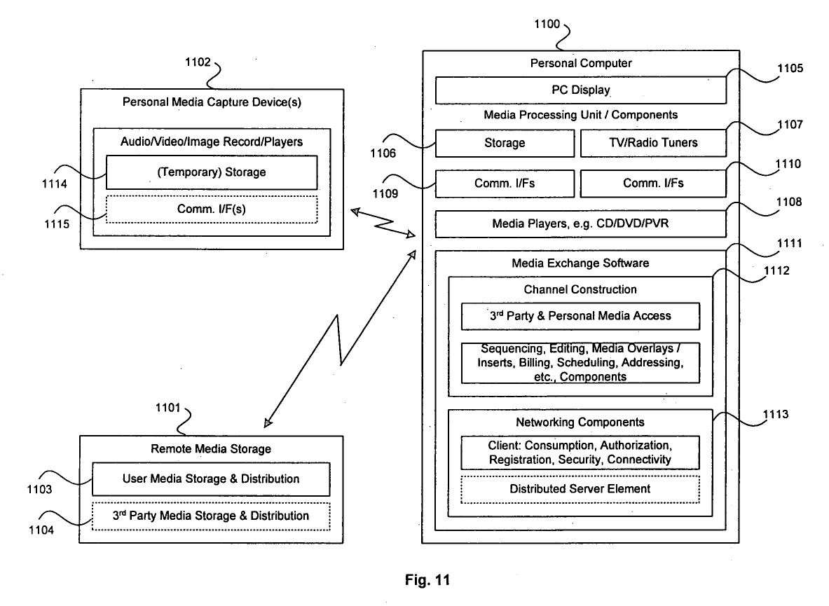

FIG. 11 illustrates connectivity between a PC 1100, remote media storage 1101, and personal media capture devices 1102 when the PC 1100 is used as the primary distributor of digital media such as in the case of PC-to-PC operation, in accordance with an embodiment of the present invention. The personal media capture devices 1102 and remote media storage 1101 connect to the PC 1100 via a wireless or wired connection. The remote media storage 1101 provides user media storage and distribution 1103 as well as third party media storage and distribution 1104. The personal media capture devices 1102 provide temporary storage 1114 and communication interfaces 1115.

Viewing is done using a PC monitor 1105 instead of a television screen. The PC 1100 may include storage 1106, TV/radio tuners 1107 for media consumption, media players 1108, and communication interfaces 1109 and user interfaces 1110 similar to those for the MPS of FIG. 9A. The PC 1100 includes a media exchange software (MES) platform 1111 that provides channel construction capability 1112 and networking capability 1113. The channel construction capability 1112 allows third party and personal media access, sequencing, editing, media overlays and inserts, billing, scheduling, and addressing.

In summary, the invention may include a method and system that may provide the ability to personally program customized media channels on a media exchange network. Certain embodiments of the present invention relate to various ways to select media content and link that media content to previously set up customized media channels. Certain embodiments of the invention also provide a system for programming media content in a distributed media network.

The system may include at least one processor that may be configured to select at least one customized media channel established by a user based on at least one input from the user. A display interface may be utilized for the input selection. The processor may identify media for one or more of the selected customized media channels based on the user's input and selection. The identified media may be presented by the processor in one or more of the customized media channels. The processor may also display the identified media in a corresponding channel view of one or more of the identified customized media channels based on the user's selection and identification. The media may also be scheduled for display in the corresponding channel view of the identified customized media channels by the processor. Accordingly, in instances where new media may become available, the processor may update or otherwise cause the channel view of the corresponding customized media channels to be updated with the newly available media. The identified media may also be transferred by the processor to one or more of the customized media channels.

In accordance with the invention, the processor may receive a selection or otherwise select the identified media from a third party and transfer the selected media from a third party storage into one or more of the customized media channels. Furthermore, although the media may be transferred directly into the customized media channels, the processor may queue the media prior to the transfer. In this regard, queuing of the media by the processor may be based on exemplary factors such as bandwidth usage, delivery cost and/or a delivery schedule. Notwithstanding, the processor may select the identified media based on a device view and/or a media view. In this regard, the processor may receive a selection corresponding to the identified media based on the device view and/or a media view. In another aspect of the invention, the processor may also be configured to control presentation of the identified media through a graphical user interface corresponding to the channel view. The processor may be a media processing system processor, a media peripheral processor, a customized computer processor, a storage system processor and a customized computer executing media exchange software processor.

Accordingly, the present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for programming media content in a distributed media network, the method comprising:
selecting at least one customized media channel established by a user based on at least one input from said user;
identifying at least one of media, data and service for said selected at least one customized media channel; and
presenting directly in said at least one customized media channel, said identified at least one of media, data and service.

2. The method according to claim 1, further comprising displaying said identified at least one of media, data and service in a channel view corresponding to said at least one customized media channel.

3. The method according to claim 2, further comprising scheduling said display of said identified at least one of media, data and service in said channel view corresponding to said at least one customized media channel.

4. The method according to claim 2, further comprising updating said display with newly available at least one of media, data and service in said channel view corresponding to said at least one customized media channel.

5. The method according to claim 1, further comprising transferring said identified at least one of media, data and service to said at least one customized media channel.

6. The method according to claim 1, further comprising selecting said identified at least one of media, data and service from a third party.

7. The method according to claim 6, further comprising transferring said selected at least one of media, data and service from a storage associated with said third party into said at least one customized media channel.

8. The method according to claim 7, further comprising queuing said at least one of media, data and service prior to said transfer, said queuing based on at least one of a bandwidth usage, a delivery cost and a delivery schedule.

9. The method according to claim 1, further comprising receiving said selection of said identified at least one of media, data and service based on at least one of a device view and a media view.

10. The method according to claim 1, further comprising controlling said presentation of said identified at least one of media, data and service from a graphical user interface corresponding to a channel view.

11. A machine-readable storage having stored thereon, a computer program having at least one code section for programming media content in a distributed media network, the at least one code section being executable by a machine for causing the machine to perform steps comprising:
selecting at least one customized media channel established by a user based on at least one input from said user;
identifying at least one of media, data and service for said selected at least one customized media channel; and
presenting directly in said at least one customized media channel, said identified at least one of media, data and service.

12. The machine-readable storage according to claim 11, further comprising code for causing display of said identified at least one of media, data and service in a channel view corresponding to said at least one customized media channel.

13. The machine-readable storage according to claim 12, further comprising code for scheduling said display of said identified at least one of media, data and service in said channel view corresponding to said at least one customized media channel.

14. The machine-readable storage according to claim 12, further comprising code for causing update of said display with newly available at least one of media, data and service in said channel view corresponding to said at least one customized media channel.

15. The machine-readable storage according to claim 11, further comprising code for transferring said identified at least one of media, data and service to said at least one customized media channel.

16. The machine-readable storage according to claim 11, further comprising code for selecting said identified at least one of media, data and service from a third party.

17. The machine-readable storage according to claim 16, further comprising code for transferring said selected at least one of media, data and service from a storage associated with said third party into said at least one customized media channel.

18. The machine-readable storage according to claim 17, further comprising code for queuing said at least one of media, data and service prior to said transfer, said queuing based on at least one of a bandwidth usage, a delivery cost and a delivery schedule.

19. The machine-readable storage according to claim 11, further comprising code for receiving said selection of said identified at least one of media, data and service based on at least one of a device view and a media view.

20. The machine-readable storage according to claim 11, further comprising code for controlling said presentation of said identified at least one of media, data and service from a graphical user interface corresponding to a channel view.

21. A system for programming media content in a distributed media network, the system comprising:
at least one processor that selects at least one customized media channel established by a user based on at lest one input from said user;
said at least one processor identifies at least one of media, data and service for said selected at least one customized media channel; and
said at least one processor presents directly in said at least one customized media channel, said identified at least one of media, data and service.

22. The system according to claim 21, wherein said at least one processor displays said identified at least one of media, data and service in a channel view corresponding to said at least one customized media channel.

23. The system according to claim 22, wherein said at least one processor schedules said display of said identified at least one of media, data and service in said channel view corresponding to said at least one customized media channel.

24. The system according to claim 22, wherein said at least one processor causes said display to be updated with newly available at least one of media, data and service in said channel view corresponding to said at least one customized media channel.

25. The system according to claim 21, wherein said at least one processor transfers said identified at least one of media, data and service to said at least one customized media channel.

26. The system according to claim 21, wherein said at least one processor selects said identified at least one of media, data and service from a third party.

27. The system according to claim 26, wherein said at least one processor transfers said selected at least one of media, data and service from a storage associated with said third party into said at least one customized media channel.

28. The system according to claim 27, wherein said at least one processor queues said at least one of media, data and service prior to said transfer, said queuing based on at least one of a bandwidth usage, a delivery cost and a delivery schedule.

29. The system according to claim 21, wherein said at least one processor receives said selection of said identified at least one of media, data and service based on at least one of a device view and a media view.

30. The system according to claim 21, wherein said at least one processor controls said presentation of said identified at least one of media, data and service from a graphical user interface corresponding to a channel view.

31. The system according to claim 21, wherein said at least one processor is at least one of a media processing system processor, a media peripheral processor, a customized computer processor, a storage system processor and a customized computer executing media exchange software processor.
